(19) United States
(12) Patent Application Publication
(10) Pub. No.: US 2012/0252488 A1
(43) Pub. Date: Oct. 4, 2012

(54) TRACKING AND MONITORING DEVICE AND SYSTEM FOR A SHIPPING CONTAINER

(75) Inventors: Avi Hartmann, Binyamina (IL); Uri Hartmann, Tel Aviv (IL); Doron Kedem, Tel Aviv (IL)

(73) Assignee: Starcom GPS Systems Ltd., Ramat Gan (IL)

(21) Appl. No.: 13/515,795

(22) PCT Filed: Oct. 20, 2010
(86) PCT No.: PCT/IL2010/000859

§ 371 Date: Jun. 13, 2012

Related U.S. Application Data
(60) Provisional application No. 61/284,127, filed on Dec. 14, 2009.

(51) Int. Cl. H04W 24/00

(52) U.S. Cl. 455/456.1

(57) ABSTRACT

A tracking and monitoring device for a shipping container has a body section attachable to an inside surface of the container proximate the door frame such that an end protrudes through a gap in the door frame. Security sensors integrally mounted in the body section are coupled to a CPU for detecting a respective security event. A global position sensor in the body section provides a position signal, and a cellular or satellite modem and a long-range antenna in the body section allow long range communication with a remote monitoring center. Power is provided to the device and associated components via a battery. In order to minimize power consumption, the CPU is normally dormant and a power management controller monitors battery power level and awakens the CPU in response to sensor signals and external interrogation signals or interrupts.

### CROSS-REFERENCE TO RELATED APPLICATIONS

This application is a U.S. national stage application filed under 35 U.S.C. §371 of International Patent Application PCT/IL2010/000859, accorded an international filing date of Oct. 20, 2010, which claims the benefit of U.S. Provisional Patent Application No. 61/284,127 filed Dec. 14, 2009, which applications are incorporated herein by reference in their entirety.

### BACKGROUND

1. Technical Field

This invention relates to the management and security of containers such as used for shipping merchandise.

2. Description of the Related Art

Shipping of merchandise in containers that are sealed, locked and have a security seal, has reduced the amount of merchandise stolen in transit. Three methods are usually used to steal from the containers: breaking the locks and forcing the doors, cutting an opening in the walls of the container or removing the pins that hold the doors hinges in place and removing the doors.

For certain goods and containers, it is vital to control the conditions inside the container—especially with refrigerated containers (REEFERS), so that the goods reach their final destination in a state fit to be used. In many cases, if the conditions under which the goods are shipped are not to the required standards, their use may be dangerous and even cause death, as in the case of medicines. The parameters that need to be monitored include: temperature of frozen goods, running temperature of cooling units and their mechanical status, internal temperature of the container and if it exceeds the permitted range, percentage of moisture, oxygen and carbon dioxide in the container and is the container connected to a power supply. In some cases it may even be necessary to know the hardware and software versions of temperature control equipment to facilitate updating and maintenance.

During some stage of the shipment, the container may receive some knocks during loading or unloading or even during overland transportation if, for example, the truck has to brake suddenly. Sometimes the damage is visible, but sometimes the container appears to be fine but the goods inside are damaged. In cases like this, it is important to know who caused the damage and where in order to claim compensation later.

These factors have increased the demand for some means to track and monitor containers. Any solution to these problems must take the following into account:
1. Need for electrical power: Since the container has no integral power source, the installed unit must have its own power supply that will last for as long as is needed.
2. Environment: Containers are stacked together and over a large area both in port and on board. This is a harsh environment for good communication signals.
3. Communication: communication presents a number of challenges that have to be addressed: good communication with containers at the bottom of a stack, adequate communication with sensors in the container, communication over long distances (international) and on the ship.
4. Mechanics: the mechanics of the unit inside the container must provide solutions for a number of factors including being waterproof, convenient location where the unit will not be damaged and that will not interfere with the packing and unpacking of the container and situated in a place that makes theft difficult.
5. Simplicity: the unit must be easy and quick to install and remove.

Current approaches can be divided into a number of categories:

1. Mechanical solutions including sophisticated locks and locking systems.

2. Electronic solutions including sensors that detect anomalies and broadcast a warning.

3. Combination of technical and electronic solutions that include a “smart lock”, sensors and a transmitting unit.

Owing to the need to provide electrical power and communications capabilities, most known approaches utilize RF or RFID frequencies with the solution being a local one only, within the port or between the container and the truck driver. Some hitherto-proposed approaches send a notification to a hand-held computer. For a number of reasons, many of the available solutions do not provide for a built in international communications (GPRS or satellite). Also, many solutions are cumbersome and others are easy to steal or damage.

WO 06/124377 discloses a security device adapted to sense at least one condition of a container that is programmably armed to implement the securing and transmits information relating to the at least one sensed condition to a location outside the container. A remote arming plug is adapted to be removably coupled to the security device and has a unique identifier to be communicated to the container security device to initiate an arming sequence of the container security device. The remote arming plug is adapted to be applied as an integrated deployable seal to at least one sealing location to physically secure the container.

US 2004/0100379 discloses a monitoring system for a container and contents that includes a device, a reader, a server, and a software backbone. The device communicates with the reader in order to determine the security and/or location of the container to which the device is attached. The reader transmits the information from the device to the server. The device determines if a security condition has occurred based on at least one sensor located on or in the container.

The device disclosed in US 2004/0100379 is affixed to the inside surface of a container proximate the door, so that a first end of the device protrudes through door frame near the hinge, while the remainder is secured inside the container. The device includes an antenna, an RF/baseband unit, a microprocessor, a memory, and a door sensor. The device may also include an interface for attachment of additional sensors to monitor various internal conditions of the container such as, for example, temperature, vibration, radioactivity, gas detection, and motion. Any such additional sensors are separate units that are independently coupled to the microprocessor. The antenna allows for data exchange with the reader of information such as, for example, status and control data, may be exchanged. The reader may be configured as a handheld reader, a mobile reader, or a fixed reader. The mobile reader is basically a fixed reader with a GPS interface, typically utilized in mobile installations (e.g., on trucks, trains, or ships using existing GPS, AIS or similar positioning systems) to secure, track, and determine the integrity of the container in a manner similar to that of the hand-held reader.

In such a system, it is possible to identify a location of the container, either manually using a hand-held reader or when the container passes within communication range of the reader and exchanges data therewith. In other words, the location of the container is determined only as a function of the fixed (or moveable) location of the reader and requires either that the reader be brought into communication range of the container or that the container reaches a location that is in communication range with a reader. This means that if the container gets lost or is stolen and does not pass within range of a reader, there is no way that the container can be tracked. Moreover, the system described in US 2004/0100379 does not report real time events such as fall, tilt, damage, impact and breaking into the container.

During use of the system described in US 2004/0100379 security events detected by one or more sensors are logged in real time and stored in the memory for subsequent analysis. Only when the data is actually read by the reader, is the data then conveyed via a communications network, which may be Internet- or satellite-based, to a server, which maintains a security record. However, the server remains ignorant of any security events until communication is established between the device and the handheld reader and only at the initiative of a human who carries and operates the hand-held reader. This severely curtails the ability to take evasive action since by the time a security event is logged by the server it may be too late to take evasive or remedial action.

Real-time event monitoring is well-known per se and there are many vehicle fleet management and tracking systems that employ GPS in combination with GSM or GRSM for the purpose of conveying alerts in real time to a central monitoring system. Reference is made, for example, to US 2008/0125965 and U.S. Pat. No. 7,212,829. However, the conventional approaches adopted by such systems are not directly applicable to shipping containers for a number of reasons.

First, since shipping containers need to be sea faring, they are subject to hazards not normally encountered by land-based tracking devices. Thus, to be sea-worthy, the sensors and tracking modules must withstand the unique environment and be protected against the salty atmosphere commonly found at sea.

Secondly, while the vehicle's battery is used to power land based tracking devices and can hold sufficient charge for the complete duration of the vehicle or of a complete leg of the journey, this is not the case with shipping containers, which can be at sea for many weeks. This means that while rechargeable batteries in tracking devices of land-based vehicles may be constantly recharged, the tracking device of a shipping container must be capable of operating continuously for prolonged periods of time while relying on a self-contained relatively small battery yet without battery replacement or recharging for the entire course of a shipment.

These requirements have militated against provision of real-time tracking devices for sea-based shipping containers.

### BRIEF SUMMARY

One or more embodiments of the present disclosure provide an improved monitoring system that is suitable for a sea-worthy shipping container, and which allows continuous and automatic tracking and management of the container in real time during prolonged inland and sea voyages and which is based on a customized self-contained container tracking device.

According to an embodiment of the disclosure there is a provided a container device for tracking a sea-worthy shipping container, said container device comprising:

a sealed body section configured for withstanding harsh environments and for attachment to an inside surface of a container proximate a door frame thereof such that a first end of the body section protrudes through a gap in the door frame,

one or more security sensors integrally mounted in the body section and coupled to a processing unit for detecting a respective security event and which is normally dormant so as to minimize power consumption,

a global position sensor integrally mounted in the body section and coupled to the processing unit for providing a position signal,

a cellular or satellite modem integrally mounted in the body section and coupled to the processing unit for providing data communication carrier via long range networks,

a sealed battery housing within the body section for accommodating a battery for providing power to the container device and to the sensors and the cellular or satellite modem therein,

a power management controller for monitoring battery power level and being responsive to sensor signals and external interrogation signals or interrupts for awakening the processing unit, and

an antenna module mounted at the first end of the body section and coupled to the processing unit, said antenna module including at least one long-range antenna for effecting continuous real time tracking and communication with a remote tracking server for informing the tracking server of an instantaneous location in space of the container and any security events.

### BRIEF DESCRIPTION OF THE SEVERAL VIEWS OF THE DRAWINGS

In order to understand the disclosure and to see how it may be carried out in practice, embodiments will now be described, by way of non-limiting example only, with reference to the accompanying drawings, in which:

FIG. 1 is a pictorial perspective view of a module according to an embodiment of the invention;

FIGS. 2 and 3 are block diagrams showing schematically a detail of the module shown in FIG. 1;

FIG. 4 is a pictorial perspective view showing further details of the module;

FIG. 5 is a pictorial view showing internal details of the module;

FIG. 6 is a schematic representation showing a system for tracking containers containing modules according to the disclosure; and

FIG. 7 is a map depicting real-time tracking of containers by a remote monitoring center.

### DETAILED DESCRIPTION

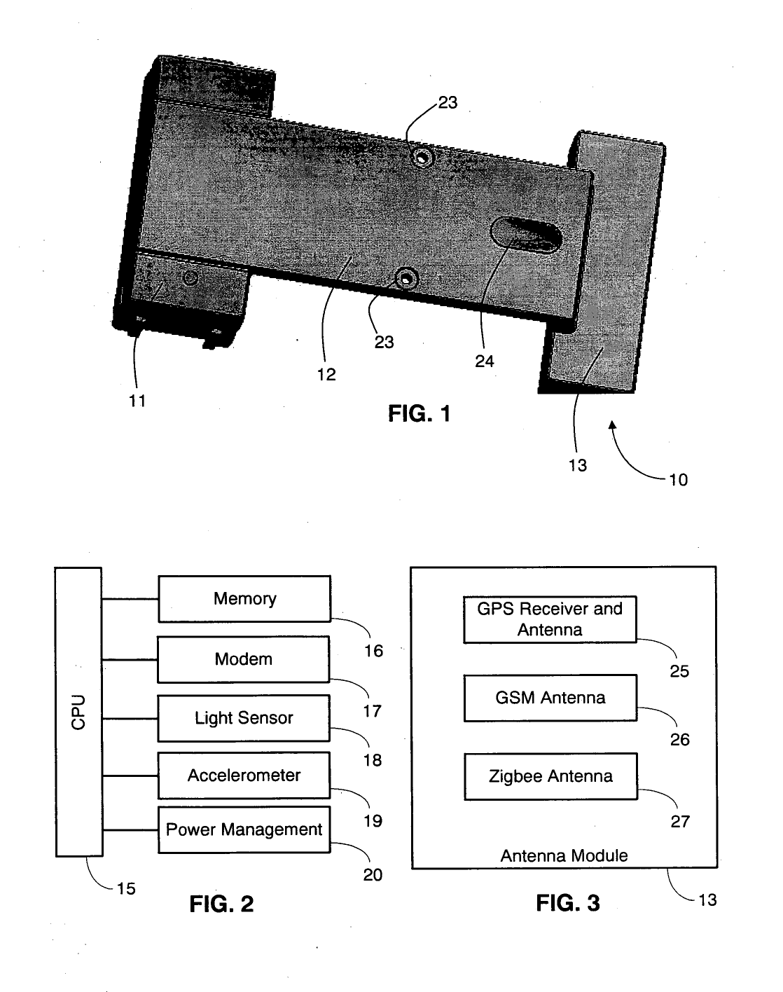

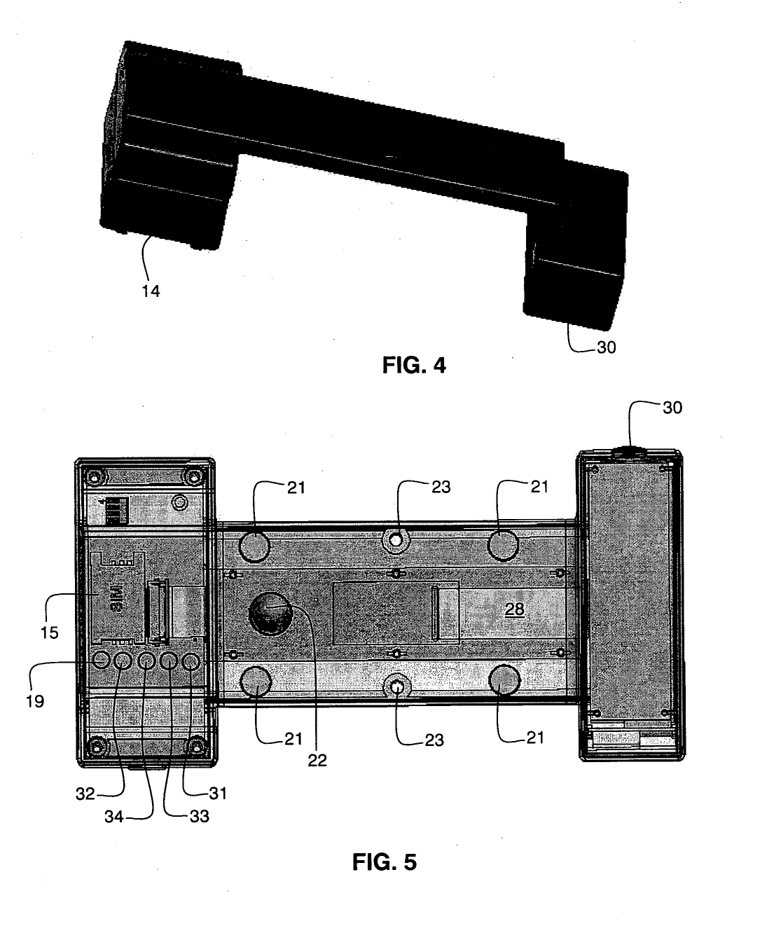

FIGS. 1 to 5 show perspective and schematic views of a container device 10 according to the invention suitable for mounting on an internal wall of a container near the door-hinge. The device 10 comprises a processor module 11 that, in use, is disposed inside the container, a second elongated body section in the form of an arm 12 that is magnetically attached or permanently fixed by screws to the inside doorframe surface of the container and an antenna module 13 that projects out of the container and houses one or more antennas.

The processor module 11 houses a re-chargeable add-on battery pack 14 for independent power supply to the device 10. The battery 14 is a rechargeable type with a supplied wall-mounted type charger via a miniature built-in port on the battery housing itself.

The processor module 11 of the device 10 comprises a CPU 15 (constituting a processing unit) including a memory 16 and to which there are coupled a cellular receiver/transmitter modem 17 suitable for operation in a GSM, HS GSM or CDMA networks, a high-sensitive light sensor 18 for providing an alert signal in response to entry of light into the container and an accelerometer 19 for low-hard impact and fall detection. A power management controller 20 constantly monitors the battery power level and is responsive to sensor signals and/or external interrogation signals or interrupts for awakening the CPU 15 for the required response.

The arm 12 links the internal and external parts of the module. Typically the arm 12 is formed of ferromagnetic material allowing it to be supported on the inner metal doorframe surface of the container by strong permanent magnets 21. This obviates the need for fixtures inside the container and simplifies fast installation and removal of the module. A contact sensor 22 in the form of an electronic pushbutton/micro-switch on the inner part of arm 12 is depressed when the device 10 is attached against the inner doorframe surface of the container and is released when the device 10 is removed; thereby signaling if the device 10 is mounted or removed. Alternatively (or additionally) the device 10 may be fixed to the inner doorframe wall of the container using bolts and, to this end, screw-holes 23 are provided. An external surface of the arm 12 supports a door sensor 24 to signal when door is closed or opened, and which may be in the form of an electronic pushbutton/micro-switch that is depressed or released by the door when closed or opened. The arm 12 and compartment 13 are ultrasonically welded to be water resistant and can withstand harsh environments.

The antenna module 13 is positioned outside of the container and serves as an antenna module for housing a GPS receiver and antenna 25, a cellular or satellite antenna 26 (constituting a long-range antenna) and a ZigBee antenna 27 (constituting a short-range antenna). The GPS receiver and antenna 25 and the ZigBee antenna 27 are off-the-shelf modules that are fixedly mounted inside the antenna module and connected to the processor 17 by a flexible PCB 28 (see FIG. 5) that runs along and are enclosed by the arm 12. The antenna module 13 is water resistant and is recessed in a metal groove along the container's doorframe therefore being less noticeable. The cellular or satellite antenna 26 facilitates long-range communication and is coupled by wires to a communication processor (not shown) that is housed within the processor module 11. The ZigBee antenna 27 facilitates short-range communication and can receive data from independent sensors installed in the container. It will be appreciated that other forms of communication may also be provided such as long-range GSM, HS GSM, CDMA, or Satellite, mid-range WiMAX or WiFi and short-range RF, RFID, BlueTooth™ allowing communication between multiple devices 10 or between devices 10 and external sensors or other devices. Communication between devices 10 allows a container to be externally monitored even if its long range communication is faulty. In such case, the faulty device can relay the information over the short range network to another device that will forward the information over the long range infrastructure to a remote tracking server. This allows data of all modules within short broadcast range to be backed up.

The GPS receiver and antenna 25 serves as a location module for providing a real-time signal indicating the container's location in space. Other Satellite-based protocols may also be used, such as Galileo, Glonass and Ground Cellular Cells (all of which are known in the art).

Associated with the device 10 are various sensors some of which have already been described. Thus, the contact sensor 22 serves as an installation/mounting sensor incorporated on the inner part of the arm 13 to monitor and signal whether the device 10 is mounted on the doorframe of the container or removed therefrom. The door sensor 24 monitors and signals if the door is open or closed. An operation electronic pushbutton micro-switch 30 on the lower part of the antenna module is manually actuated after installation for initiating a system check to ensure that all components are functioning properly and that there is proper communication between the sensors and the external antennas. The active light sensor 18 monitors the ambient light level in the container and produces an alert upon a prescribed deviation. A temperature sensor 31 likewise monitors the ambient temperature within the container and produces an alert upon a prescribed deviation. Oxygen and CO₂ sensors 32 monitor the ambient oxygen and CO₂ levels in the container and produce alerts upon prescribed deviations. A radioactive sensor 33 monitors the radioactive level in the container and produces an alert upon a prescribed deviation. The accelerometer 19 monitors movement and impact levels of the container and produces an alert upon a prescribed deviation. A humidity sensor 34 monitors the ambient humidity level in the container and produces an alert upon a prescribed deviation. In all cases, the term deviation can be an indication that the measured parameter exceeds or is less than a given threshold.

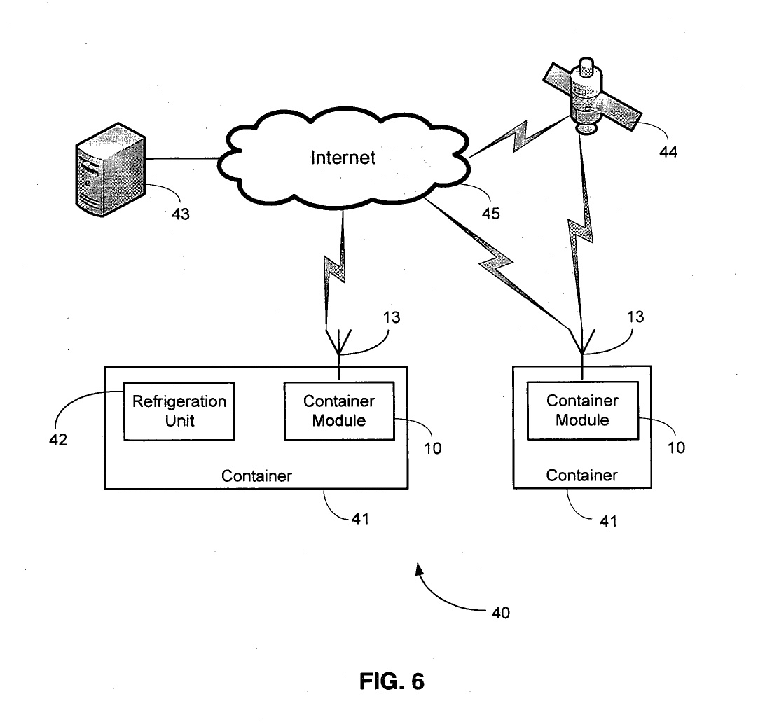

FIG. 6 is a schematic representation showing a system 40 for tracking containers 41 each containing a device 10 as described above. For the sake of complete explanation, at least one of the containers 41 is used to transport cold food and includes a refrigeration unit 42. The system 40 includes a server 43 that is operated by a tracking center (not shown) for monitoring containers in real time. Failure of the refrigeration unit 42 is another example of a security event that must be reported to the server. The refrigeration unit 42 can be remotely operated by the server as well as being monitored and activated by the on-board CPU 15. Each of the devices 10 includes an antenna module 13 shown schematically in FIG. 6, it being recalled that multiple antennas may be provided, each operating over a predetermined range and protocol. The GPS antenna 25 (shown in FIG. 3) communicates with two or more satellites 44, which convey spatial location to the server 43 via the Internet 45.

Logic

The following logic states apply to the device 10:

Passive State—The device 10 is powered. None of the contact sensor 22, the door sensor 24 and the operation pushbutton is depressed.

Armed State—All sensors are connected directly to the power management controller 20. When the device 10 is armed, the power management controller is the only subsystem that is active. The entire system becomes alive upon any one or more of the sensors providing an indication or alert signal to the power management controller.

Silent Alarm—In this state the power management controller 20 awakens the CPU 15 to recheck on an intercepted signal. If an intercepted signal repeats more than a specified number of times that may be preset by the customer, the power management controller 20 awakens the location and radio modules. Otherwise, all the sensors as well as the power management controller go into a sleep mode.

Emergency—The system is up and verifies an intercepted signal several times before activating the device 10, which then sends the location and information on the sensor type waiting for message acknowledgment from the network before shutting down the entire system then switching to an armed state.

The power management controller 20 is configured so as to cause minimum intervention commensurate with providing real time monitoring and tracking, so that the CPU 15 remains dormant and power consumption is reduced to a minimum. However, in order to provide real time monitoring and tracking, it is nevertheless necessary that the power management controller 20 awaken the CPU 15 periodically and convey the current status to the server 43. Likewise, the server 43 can itself interrogate the device 10 but this also drains the battery in the device. Consequently, a reasonable balance has to be drawn between obtaining updated location and status of the container and preserving battery power.

In one embodiment of the disclosure, the time period between interrogations, whether they be remotely initiated by the server 43 or locally by the power management controller 20 may be pre-set and stored either in the memory 16 of the device 10 or in the server 43. Whenever, the power management controller 20 awakens the CPU 15 it associates with the current status a timestamp that is stored with the status, in the memory 16. Only when the lapsed time from the most recent timestamp exceeds the preset time interval between interrogations, does the power management controller 20 awaken the CPU 15 for determining a subsequent status of the container. Data conveyed to the server 43 likewise includes a respective timestamp, thus allowing the server to operate in like manner. Obviously, a security event will override this logic.

The time interval between interrogations may be automatically computed as a function of estimated voyage time, so that for long voyages lasting weeks or months, the time interval between interrogations is reduced (in absolute terms) so as to conserve battery, while for short voyages more frequent interrogations can be permitted.

User Interface—Application/Software

The server 43 incorporates a user interface that is accessible via a workstation or computer terminal coupled to the server 43 either directly or remotely and enables an operator to display a specified container on a map in real-time, and send messages and commands to a specified module 10. For example, the remote operator can cause the module to change transmission intervals or to turn on the refrigeration system 42, if appropriate. The user interface also allows the operator to generate a variety of informative reports, and to predefine relevant alert messages to be sent to a list of cellular phone recipients. The user interface may be customized geographically to support different languages and different street-level maps depending on geographic location.

The user interface system provides two interfaces:

Online software application:—This resides on the server 43 for access by an end user and enables the end user to customize and define various alerts for each event and determine if an alert is to be sent to a mail recipient or one or more cellular subscribers etc. For instance, an event may be initiated only if a container arrives at its destination and the door is opened. Likewise, an event may be initiated if during the transportation of a container its ambient temperature increases and it is more than a specified distance from destination.

Procedures software application:—This is aimed at emergency events that require immediate response, for instance theft or temperature increase and allows the end user to define in advance the right procedure to be taken upon occurrence of such an event. For instance, if an unauthorized door open event occurs, a police car may be rushed to site to handle the situation. Or if temperature exceeds a preset threshold, a technician may be immediately called to site to handle and fix the problem.

It is to be noted that event-driven interfaces and event-handling in general are well-known in the art and these features are therefore not described in detail. However, the invention permits event-handling to be implemented in real-time only by virtue of the fact that, unlike hitherto-proposed systems, the containers are tracked in real-time and the instantaneous location of each container is thus known in real-time. This permits not only tracking and monitoring of containers, but also allows event-driven remedial action to be carried out by entities that are external to the container and that are automatically dispatched to the container based on location data provided by the server 43.

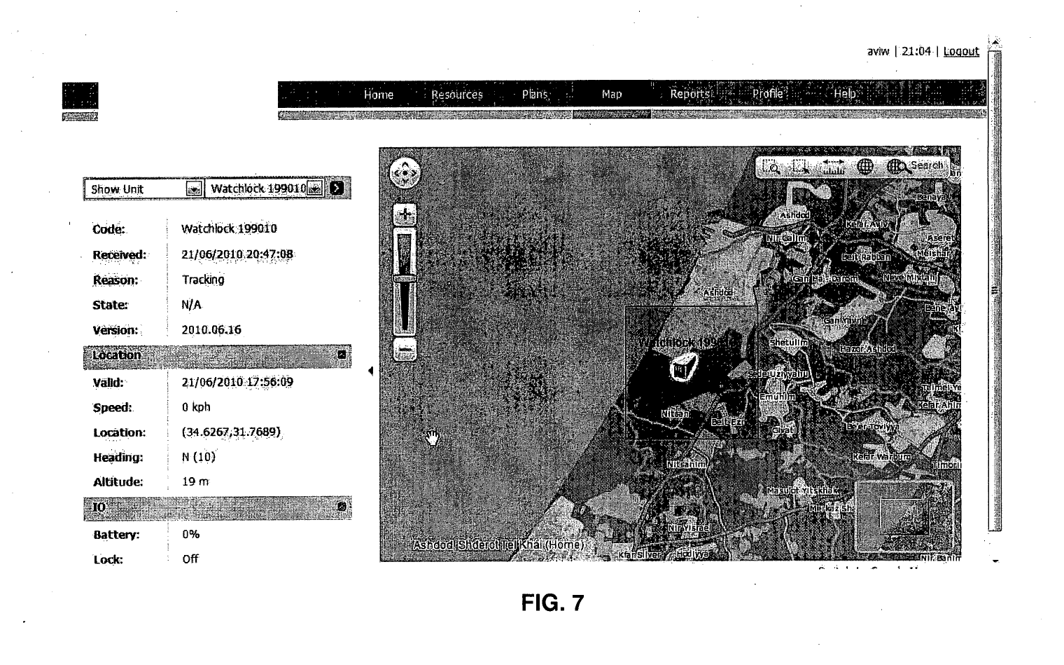

For example, FIG. 7 shows a map that permits an operative to see at a glance the location of each tracked container in real-time and to determine whether the container is on schedule. The operator can manually initiate communication with the module in the container so as to check, for example, the temperature, the status of various sensors, CO2 levels and so on. However, the sensors themselves generate signals that are processed either by the external server 43 or by the CPU 15 within the module itself, for establishing events and, upon occurrence of events thus established, for taking action in accordance with procedures preset by the end user.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A container device for a container tracking and monitoring system used for tracking a sea-worthy shipping container, said container device comprising:
a sealed body section configured for withstanding harsh environments and for attachment to an inside surface of a container proximate a door frame thereof such that a first end of the body section protrudes through a gap in the door frame,
one or more security sensors integrally mounted in the body section and coupled to a processing unit for detecting a respective security event, the processing unit being normally dormant so as to minimize power consumption,
a global position sensor integrally mounted in the body section and coupled to the processing unit for providing a position signal,
a cellular or satellite modem integrally mounted in the body section and coupled to the processing unit for providing data communication carrier via long range networks,
a sealed battery housing within the body section for accommodating a battery for providing power to the container device and to the sensors and the cellular or satellite modem therein,
a power management controller for monitoring battery power level and being responsive to sensor signals and external interrogation signals or interrupts for awakening the processing unit, and
an antenna module mounted at the first end of the body section and coupled to the processing unit, said antenna module including at least one long-range antenna for effecting continuous real time tracking and communication with a remote tracking server for informing the tracking server of an instantaneous location in space of the container and any security events;
wherein:
the antenna module includes a short-range antenna for allowing short-range communication between respective devices in different containers, and
the processing unit is responsive to impaired long-range communication for conveying data to a nearby device in another container via the short-range antenna for relaying to the tracking server.

2. The device according to claim 1, comprising:
a high-sensitive light sensor coupled to the processing unit for providing an alert signal in response to entry of light into the container, and
an accelerometer for providing a signal upon impact or sudden movement.

3. (canceled)

4. (canceled)

5. The device according to claim 1, wherein the body section is formed of ferromagnetic material allowing it to be supported on an inner metal surface of the container by one or more permanent magnets.

6. The device according to claim 1, further comprising a contact sensor for providing an alert signal when the device loses contact with the inner surface of the container.

7. The device according to claim 1, further comprising a door sensor coupled to the processing unit for producing a signal when a door of the container is closed or opened.

8. The device according to claim 1, wherein the body section is welded to the processor module and to the antenna module.

9. The device according to claim 1, wherein the one or more security sensors include any one or more in the group consisting of: temperature sensor, Oxygen and CO₂ sensors, radioactive sensor, accelerometer, humidity sensor.

10. A system for tracking sea-based shipping containers each containing a device according to claim 1, said system including:
a server for sea-worthy shipping tracking containers in real time, each of the containers containing a module that includes an antenna module having a GPS antenna for communicating with two or more satellites for conveying to the server spatial location of the respective module;
said antenna module including a long-range antenna for conveying data indicative of security events to the server and being configured to allow the server to communicate with a device in a specific container.

11. The system according to claim 10, wherein at least one of the containers is used to transport cold food and includes a refrigeration unit.

12. The system according to claim 10, wherein the server stores a user interface accessible by an end user over the Internet.

13. The system according to claim 12, wherein the user interface allows the end user to customize and define alerts for different security events and to define a destination for each alert and a mode of communication therewith.

14. The system according to claim 12, wherein the user interface allows the end user to define a procedure to be taken upon occurrence of an event.

15. The system according to claim 10, wherein:
the time period between interrogations is preset and stored in a memory of the device;
the power management controller awakens the CPU and associates with the current status a timestamp that is stored with the status in the memory
the power management controller is responsive to a measured lapsed time from the most recent timestamp exceeding the preset time interval between interrogations for awakening the CPU for determining a subsequent status of the container.

16. The system according to claim 15, wherein the time interval between interrogations is automatically computed as a function of estimated voyage time.
